(19) United States
(12) Patent Application Publication
(10) Pub. No.: US 2024/0340141 A1
(43) Pub. Date: Oct. 10, 2024

(54) NODE AND USER EQUIPMENT IN WIRELESS COMMUNICATION SYSTEM AND METHOD PERFORMED BY THE SAME

(71) Applicant: Samsung Electronics Co., Ltd., Suwon-si (KR)

(72) Inventors: Pengru LI, Beijing (CN); Qi XIONG, Beijing (CN); Feifei SUN, Beijing (CN)

(21) Appl. No.: 18/624,932

(22) Filed: Apr. 2, 2024

(30) Foreign Application Priority Data
Apr. 4, 2023 (CN) 202310355652.6
May 8, 2023 (CN) 202310513030.1
Aug. 3, 2023 (CN) 202310974603.0
Nov. 1, 2023 (CN) 202311444811.6

(51) Int. Cl. H04L 5/00; H04W 72/0453; H04W 72/232

(52) U.S. Cl. CPC H04L 5/0051; H04L 5/0012; H04W 72/0453; H04W 72/232

(57) ABSTRACT

The disclosure relates to a 5G or 6G communication system for supporting a higher data transmission rate. The present disclosure provides a node, user equipment in a wireless communication system and a method performed by the same. A method performed by a user equipment (UE) in a wireless communication system, the method comprising: receiving, from a base station, first information configuring a sounding reference signal (SRS) for positioning, wherein the first information includes information on a plurality of component carriers (CCs) which are linked for bandwidth aggregation associated with the SRS for positioning; and transmitting, to the base station, the SRS for positioning across all of the plurality of CCs.

### CROSS-REFERENCE TO RELATED APPLICATIONS

This application is based on and claims priority under 35 U.S.C. § 119 to Chinese Patent Application No. 202310355652.6 filed on Apr. 4, 2023, Chinese Patent Application No. 202310513030.1 filed on May 8, 2023, Chinese Patent Application No. 202310974603.0 filed on Aug. 3, 2023, and Chinese Patent Application No. 202311444811.6 filed on Nov. 1, 2023, all filed in the Chinese Intellectual Property Office, the disclosures of which are incorporated by reference herein in their entirety.

### BACKGROUND

### 2. Field

The present disclosure relates to the technical field of wireless communication, and more specifically, it relates to a node, user equipment in a wireless communication system and a method performed by the same.

### 2. Description of Related Art

In order to meet the increasing demand for wireless data communication services since the deployment of 4^{th} generation (4G) communication systems, efforts have been made to develop improved 5G or pre-5G communication systems. Therefore, 5G or pre-5G communication systems are also called “Beyond 4G networks” or “Post-LTE systems.”

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (COMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

### SUMMARY

A method performed by a user equipment (UE) in a wireless communication system, the method comprising: receiving, from a base station, first information configuring a sounding reference signal (SRS) for positioning, wherein the first information includes information on a plurality of component carriers (CCs) which are linked for bandwidth aggregation associated with the SRS for positioning; and transmitting, to the base station, the SRS for positioning across all of the plurality of CCs.

A user equipment (UE) in a wireless communication system, the UE comprising: a transceiver; and a controller coupled with the transceiver and configured to: receive, from a base station, first information configuring a sounding reference signal (SRS) for positioning, wherein the first information includes information on a plurality of component carriers (CCs) which are linked for bandwidth aggregation associated with the SRS for positioning; and transmit, to the base station, the SRS for positioning across all of the plurality of CCs.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features and advantages of certain embodiments of the present disclosure will be more apparent from the following description taken in conjunction with the accompanying drawings, in which:

FIG. 1 illustrates an example of a wireless network according to various embodiments of the present disclosure;

FIGS. 2A and 2B illustrate examples of wireless transmission and reception paths according to various embodiments of the present disclosure;

FIG. 3A illustrates an example of a UE according to various embodiments of the present disclosure;

FIG. 3B illustrates an example of a gNB according to various embodiments of the present disclosure;

FIG. 4 illustrates a flowchart of a method performed by a user equipment in a wireless communication system according to various embodiments of the present disclosure;

FIG. 5 illustrates a flowchart of a method performed by a node in a wireless communication system according to various embodiments of the present disclosure;

FIG. 6 illustrates a user equipment in a wireless communication system according to various embodiments of the present disclosure;

FIG. 7 illustrates a node in a wireless communication system according to various embodiments of the present disclosure;

FIG. 8 illustrates a structure of a UE according to various embodiments of the present disclosure; and

FIG. 9 illustrates a structure of a base station according to various embodiments of the present disclosure.

### DETAILED DESCRIPTION

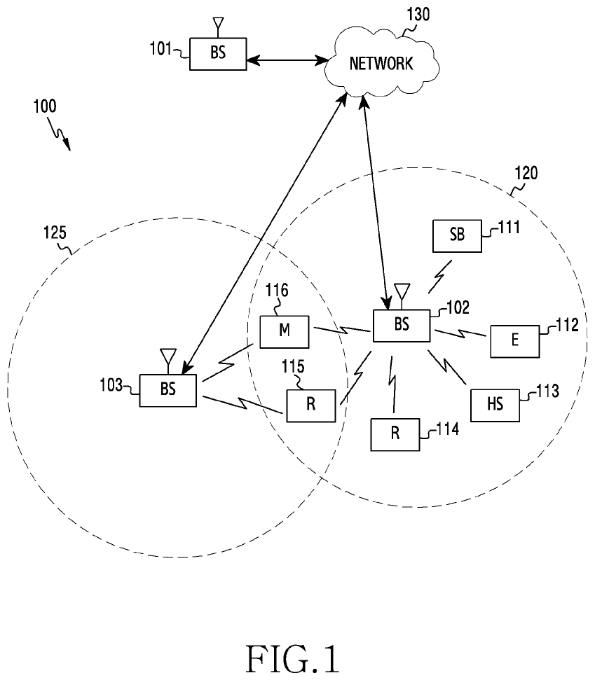

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Embodiments of the present disclosure provide a method performed by a user equipment (UE) in a wireless communication system, comprising: receiving a first message, wherein the first message includes configuration information for bandwidth aggregation of a first signal, wherein the configuration information includes a first power threshold for the bandwidth aggregation of the first signal; and transmitting the first signal based on the first power threshold if the bandwidth aggregation of the first signal is enabled.

According to embodiments of the present disclosure, the first message further includes a bandwidth aggregation related indication for indicating whether to enable or activate the bandwidth aggregation of the first signal.

According to embodiments of the present disclosure, the transmitting the first signal based on the first power threshold comprises: when a total transmission power of the first signal exceeds the first power threshold, performing one or more of the following: dropping or not aggregating one or more carriers for transmitting the first signal; reducing transmission power for the first signal across all carriers of one or more carriers for transmitting the first signal; and reducing transmission power for the first signal on a part of one or more carriers for transmitting the first signal.

According to embodiments of the present disclosure, the one or more carriers dropped or not aggregated is/are carrier(s) with a low priority or carrier(s) on which transmission power exceeds a second power threshold.

According to embodiments of the present disclosure, the configuration information includes a number of the one or more carriers for transmitting the first signal and/or indexes of the one or more carriers for transmitting the first signal.

According to embodiments of the present disclosure, when performing the dropping or not aggregating one or more carriers for transmitting the first signal, the method further comprises one or more of the following: transmitting the first signal on more than one other continuous carrier; transmitting the first signal, on a carrier with the largest bandwidth and/or the highest priority among more than one other discontinuous carrier; when there is more than one other discontinuous carrier and the more than one other discontinuous carrier includes a reference carrier, transmitting the first signal on a carrier with the largest bandwidth or on the reference carrier; and transmitting the first signal on one carrier.

According to embodiments of the present disclosure, the method further comprises one or more of the following: determining power control parameters and/or path loss reference signals for transmitting the first signal based on configuration of a reference carrier; determining path loss reference signals for transmitting the first signal based on a reference signal with the maximum reference signal received power; and determining power control parameters for transmitting the first signal based on preconfigured power control parameters, wherein alpha=1, and/or P0 of the power control parameters for transmitting the first signal is determined according to a parameter P0 of a physical random access channel (PRACH) configured in a system information block 1 (SIB1).

According to embodiments of the present disclosure, the determining power control parameters and/or path loss reference signals for transmitting the first signal based on configuration of a reference carrier further comprises: determining the power control parameters and/or path loss reference signals for transmitting the first signal on the same time unit based on configuration of a reference carrier on the same time unit.

According to embodiments of the present disclosure, the method further comprises one or more of the following: a starting resource element offset of a first symbol of resources for transmitting and/or receiving the first signal is a starting resource element offset of a reference carrier; a starting resource element offset of a first symbol of resources for transmitting and/or receiving the first signal is: a starting physical resource block of a current carrier plus a number N of guard subcarrier spacings and then taking remainder of a configured comb size for the first signal, where N is greater than or equal to 1; a starting resource element offset of a first symbol of resources for transmitting and/or receiving the first signal is: a frequency unit after removing overlapping subcarriers in frequency domain from a starting physical resource block of a carrier with a high carrier frequency at an overlap, plus a number M of the overlapping subcarriers, and then taking remainder of a configured comb size for the first signal, where M is greater than or equal to 1; and a starting resource element offset of a first symbol of resources for transmitting and/or receiving the first signal is: a frequency unit after removing overlapping subcarriers in frequency domain from a starting physical resource block of a carrier with a high carrier frequency at an overlap, plus a number M of the overlapping subcarriers, and then taking remainder of a subcarrier number 12 for the first signal.

According to embodiments of the present disclosure, the bandwidth aggregation is a continuous bandwidth aggregation.

According to embodiments of the present disclosure, the method further comprises one or more of the following: when a priority of the first signal is higher than a priority of a first downlink signal and/or a first uplink signal, transmitting the first signal and not receiving or dropping symbols or resources (or transmission) of the first downlink signal and/or not transmitting symbols or resources (or transmission) of the first uplink signal; when a priority of the first signal is lower than a priority of a first downlink and/or a first uplink signal, dropping or not transmitting symbols or resources of the first signal conflicting with the first downlink signal and/or the first uplink signal on carriers where the conflicting occurs; and when a priority of the first signal is lower than a priority of a first downlink and/or a first uplink signal, dropping or not transmitting symbols or resources of the first signal across all carriers.

According to embodiments of the present disclosure, when a priority of the first signal is lower than a priority of a first downlink signal and/or a first uplink signal, the method further comprises one or more of the following: if an interval between a time unit and/or frequency unit when decoding of scheduling indication information for the first downlink signal is completed or when the scheduling indication information for the first downlink signal is received and a starting position for transmitting the first signal is less than or not greater than a second threshold, and/or, if an interval between a time unit and/or frequency unit when it is determined to transmit the first uplink signal and a starting position for transmitting the first signal is less than or not greater than a third threshold, the UE determines the priority of the first signal as a high priority; and if after a specific number of time units before a starting position for transmitting the first signal, the UE determines that the UE is expected to receive the first downlink signal and/or transmit the first uplink signal, then the UE determines the priority of the first signal as a high priority.

According to embodiments of the present disclosure, the first message is one or more of the following: a radio resource control (RRC) message, a media access control (MAC) control element (CE) message, and downlink control information (DCI).

According to embodiments of the present disclosure, the first signal is a sounding reference signal (SRS) or a positioning reference signal (PRS).

Embodiments of the present disclosure provide a method performed by a node in a wireless communication system, comprising: transmitting a first message, wherein the first message includes configuration information for bandwidth aggregation of a first signal, wherein the configuration information includes a first power threshold for the bandwidth aggregation of the first signal; and receiving the first signal, wherein the first signal is transmitted by a user equipment (UE) based on the first power threshold.

According to embodiments of the present disclosure, the first message further includes a bandwidth aggregation related indication for indicating whether to enable or activate the bandwidth aggregation of the first signal.

According to embodiments of the present disclosure, the configuration information includes a number of the one or more carriers for transmitting the first signal and/or indexes of the one or more carriers for transmitting the first signal.

According to embodiments of the present disclosure, the method further comprises: measuring the first signal according to a number of one or more carriers for the first signal and/or indexes of one or more carriers for the first signal received.

According to embodiments of the present disclosure, the method further comprises one or more of the following: receiving the first signal on more than one continuous carrier; receiving the first signal on a carrier with the largest bandwidth and/or the highest priority; receiving the first signal on a carrier with the largest bandwidth or on a reference carrier; and receiving the first signal on one carrier.

According to embodiments of the present disclosure, the method further comprises one or more of the following: determining power control parameters and/or path loss reference signals for the UE to transmit the first signal based on configuration of a reference carrier; determining path loss reference signals for the UE to transmit the first signal based on a reference signal with the maximum reference signal received power; and determining power control parameters for the UE to transmit the first signal based on preconfigured power control parameters, wherein alpha=1, and/or P0 of the power control parameters for transmitting the first signal is determined according to a parameter P0 of a physical random access channel (PRACH) configured in a system information block 1 (SIB1).

According to embodiments of the present disclosure, the determining power control parameters and/or path loss reference signals for the UE to transmit the first signal based on configuration of a reference carrier further comprises: determining the power control parameters and/or path loss reference signals for the UE to transmit the first signal based on configuration of a reference carrier on the same time unit.

According to embodiments of the present disclosure, the method further comprises one or more of the following: a starting resource element offset of a first symbol of resources of the first signal received is a starting resource element offset of a reference carrier; a starting resource element offset of a first symbol of resources of the first signal received is: a starting physical resource block of a current carrier plus a number N of guard subcarrier spacings and then taking remainder of a configured comb size for the first signal, where N is greater than or equal to 1; a starting resource element offset of a first symbol of resources of the first signal received is: a frequency unit after removing overlapping subcarriers in frequency domain from a starting physical resource block of a carrier with a high carrier frequency at an overlap, plus a number M of the overlapping subcarriers, and then taking remainder of a configured comb size for the first signal, where M is greater than or equal to 1; and a starting resource element offset of a first symbol of resources of the first signal received is: a frequency unit after removing overlapping subcarriers in frequency domain from a starting physical resource block of a carrier with a high carrier frequency at an overlap, plus a number M of the overlapping subcarriers, and then taking remainder of a subcarrier number 12 for the first signal.

According to embodiments of the present disclosure, the bandwidth aggregation is a continuous bandwidth aggregation.

According to embodiments of the present disclosure, the method further comprises one or more of the following: when a priority of the first signal is higher than a priority of a first downlink signal and/or a first uplink signal, receiving the first signal and not transmitting the first downlink signal and/or not receiving the first uplink signal; when a priority of the first signal is lower than a priority of a first downlink and/or a first uplink signal, dropping or not receiving symbols or resources of the first signal conflicting with the first downlink signal and/or the first uplink signal on the carrier where the conflicting occurs; and when a priority of the first signal is lower than a priority of a first downlink and/or a first uplink signal, dropping or not receiving symbols or resources of the first signal across all carriers.

According to embodiments of the present disclosure, when a priority of the first signal is lower than a priority of a first downlink signal and/or a first uplink signal, the UE performs one or more of the following: if an interval between a time unit and/or frequency unit when decoding of scheduling indication information for the first downlink signal is completed or when the scheduling indication information for the first downlink signal is received and a starting position for transmitting the first signal is less than or not greater than a second threshold, and/or, if an interval between a time unit and/or frequency unit when it is determined to transmit the first uplink signal and a starting position for transmitting the first signal is less than or not greater than a third threshold, the UE determines the priority of the first signal as a high priority; and if after a specific number of time units before a starting position for transmitting the first signal, the UE determines that the UE is expected to receive the first downlink signal and/or transmit the first uplink signal, then the UE determines the priority of the first signal as a high priority.

According to embodiments of the present disclosure, the first message is one or more of the following: a radio resource control (RRC) message, a media access control (MAC) control element (CE) message, and a downlink control information (DCI).

According to embodiments of the present disclosure, the first signal is a sounding reference signal (SRS) or a positioning reference signal (PRS).

Embodiments of the present disclosure provide a user equipment (UE) in a wireless communication system, including a transceiver configured to transmit and receive signals; and a controller coupled to the transceiver and configured to perform methods performed by a user equipment (UE) in a wireless communication system according to embodiments of the present disclosure.

Embodiments of the present disclosure provide a node in a wireless communication system, including a transceiver configured to transmit and receive signals; and a controller coupled to the transceiver and configured to perform methods performed by a node in a wireless communication system according to embodiments of the present disclosure.

Embodiments of the present disclosure provide a computer-readable medium having stored thereon computer-readable instructions which, when executed by a processor, are used to implement method performed by a user equipment (UE) and/or a node in a wireless communication system according to embodiments of the present disclosure.

Embodiments of the present disclosure provide a method and device for measuring positioning reference signals across aggregated PFLs and/or carriers, which can clarify configuration related to transmission and measurement of positioning reference signals in scenarios of measuring positioning reference signals across aggregated PFLs and/or carriers.

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art and are not to be interpreted to have ideal or excessively formal meanings unless clearly defined in the present disclosure.

Technical schemes of embodiments of the present application can be applied to various communication systems, such as the global system for mobile communications (GSM) system, code division multiple access (CDMA) system, wideband code division multiple access (WCDMA) system, general packet radio service (GPRS), long term evolution (LTE) system, LTE frequency division duplex (FDD) system, LTE time division duplex (TDD), universal mobile telecommunication system (UMTS), worldwide interoperability for microwave access (WiMAX) communication system, 5th generation (5G) system or new radio (NR), etc. In addition, technical schemes of embodiments of the present application can be applied to future-oriented communication technologies.

FIG. 1 illustrates an example of a wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB.” For convenience, the terms “gNodeB” and “gNB” are used in this patent document to refer to network infrastructure components that provide wireless access for remote terminals. And, depending on the type of the network, other well-known terms such as “mobile station,” “user station,” “remote terminal,” “wireless terminal” or “user apparatus” can be used instead of “user equipment” or “UE.” For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

A gNB 102 provides wireless broadband access to the network 130 for a first plurality of user equipments (UEs) within a coverage area 120 of the gNB 102. The first plurality of UEs include a UE 111, which may be located in a small business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. A gNB 103 provides wireless broadband access to network 130 for a second plurality of UEs within a coverage area 125 of the gNB 103. The second plurality of UEs include a UE 115 and a UE 116. In some embodiments, one or more of gNBs 101-103 can communicate with each other and with UEs 111-116 using 5G, long term evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 may include any number of gNBs and any number of UEs in any suitable arrangement, for example. Furthermore, the gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, the gNB 101, 102 and/or 103 can provide access to other or additional external networks, such as external telephone networks or other types of data networks.

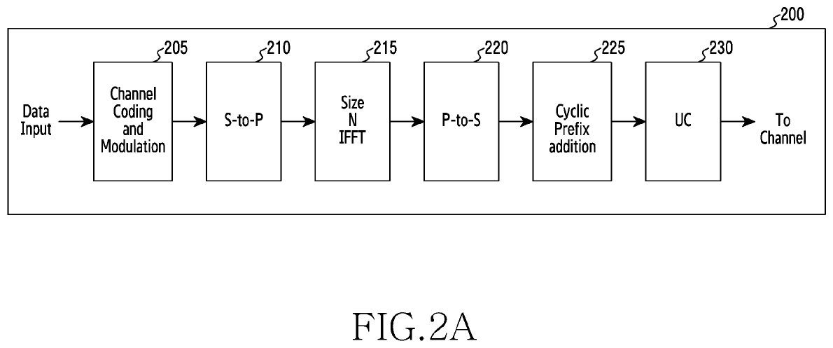

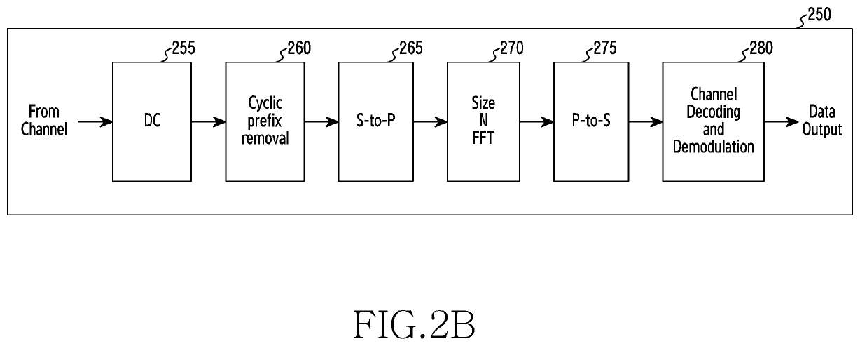

FIGS. 2A and 2B illustrate example wireless transmission and reception paths according to the present disclosure. In the following description, the transmission path 200 can be described as being implemented in a gNB, such as the gNB 102, and the reception path 250 can be described as being implemented in a UE, such as the UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a serial-to-parallel (S-to-P) block 210, a size N inverse fast Fourier transform (IFFT) block 215, a parallel-to-serial (P-to-S) block 220, a cyclic prefix addition block 225, and an up-converter (UC) 230. The reception path 250 includes a down-converter (DC) 255, a cyclic prefix removal block 260, a serial-to-parallel (S-to-P) block 265, a size N fast Fourier transform (FFT) block 270, a parallel-to-serial (P-to-S) block 275, and a channel decoding and demodulation block 280.

In the transmission path 200, the channel coding and modulation block 205 receives a set of information bits, applies coding (such as low density parity check (LDPC) coding), and modulates the input bits (such as using quadrature phase shift keying (QPSK) or quadrature amplitude modulation (QAM)) to generate a sequence of frequency-domain modulated symbols. The serial-to-parallel (S-to-P) block 210 converts (such as demultiplexes) serial modulated symbols into parallel data to generate N parallel symbol streams, where N is a size of the IFFT/FFT used in the gNB 102 and the UE 116. The size N IFFT block 215 performs IFFT operations on the N parallel symbol streams to generate a time-domain output signal. The parallel-to-serial block 220 converts (such as multiplexes) parallel time-domain output symbols from the size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal may also be filtered at a baseband before switching to the RF frequency.

The RF signal transmitted from the gNB 102 arrives at the UE 116 after passing through the wireless channel, and operations in reverse to those at the gNB 102 are performed at the UE 116. The down-converter 255 down-converts the received signal to a baseband frequency, and the cyclic prefix removal block 260 removes the cyclic prefix to generate a serial time-domain baseband signal. The serial-to-parallel block 265 converts the time-domain baseband signal into a parallel time-domain signal. The size N FFT block 270 performs an FFT algorithm to generate N parallel frequency-domain signals. The parallel-to-serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from the UEs 111-116 in the uplink. Similarly, each of UEs 111-116 may implement a transmission path 200 for transmitting to the gNBs 101-103 in the uplink, and may implement a reception path 250 for receiving from the gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as discrete Fourier transform (DFT) and inverse discrete Fourier transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

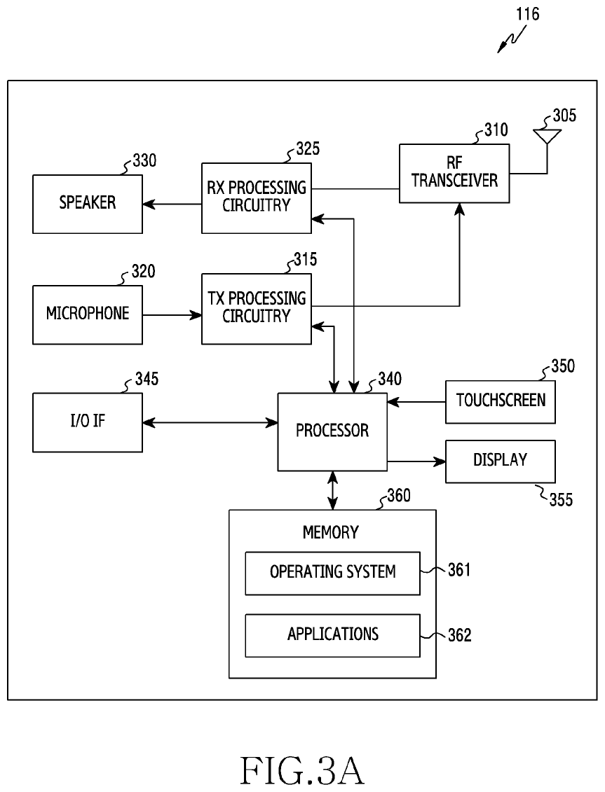

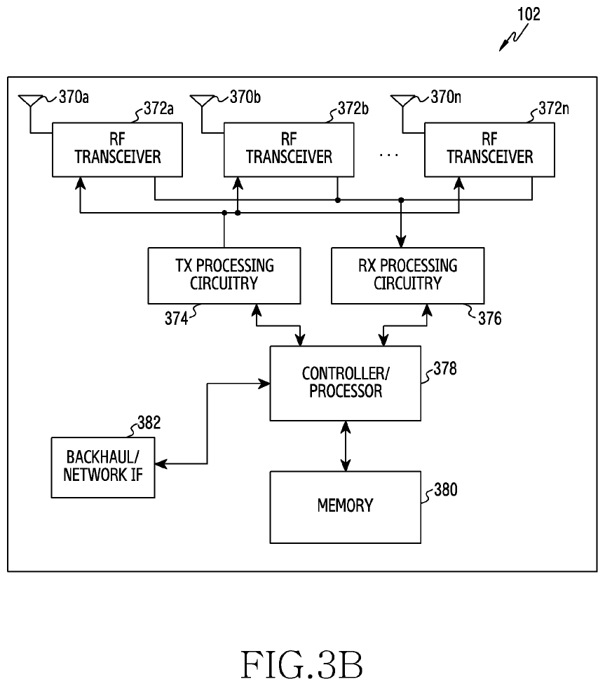

FIG. 3A illustrates an example of a UE 116 according to various embodiments of the present disclosure. The embodiment of UE 116 shown in FIG. 3A is for illustration only, and UEs 111-115 of FIG. 1 can have the same or similar configuration. However, a UE has various configurations, and FIG. 3A does not limit the scope of the present disclosure to any specific implementation of the UE.

The UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 may include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 may include a random access memory (RAM), while another part of the memory 360 may include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs may be configured to operate as other types of mobile or fixed devices.

FIG. 3B illustrates an example of a gNB 102 according to the present disclosure. The embodiment of gNB 102 shown in FIG. 3B is for illustration only, and other gNBs of FIG. 1 can have the same or similar configuration. However, a gNB has various configurations, and FIG. 3B does not limit the scope of the present disclosure to any specific implementation of a gNB. It should be noted that the gNB 101 and the gNB 103 may include the same or similar structures as the gNB 102.

As shown in FIG. 3B, the gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. The gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 may include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 may also support additional functions, such as higher-level wireless communication functions. For example, the controller/processor 378 can perform a blind interference sensing (BIS) process such as that performed through a BIS algorithm, and decode a received signal from which an interference signal is subtracted. A controller/processor 378 may support any of a variety of other functions in the gNB 102. In some embodiments, the controller/processor 378 includes at least one microprocessor or microcontroller.

The controller/processor 378 is also capable of executing programs and other processes residing in the memory 380, such as a basic OS. The controller/processor 378 may also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows the gNB 102 to communicate with other devices or systems through a backhaul connection or through a network. The backhaul or network interface 382 can support communication over any suitable wired or wireless connection(s). For example, when the gNB 102 is implemented as a part of a cellular communication system, such as a cellular communication system supporting 5G or new radio access technology or NR, LTE or LTE-A, the backhaul or network interface 382 can allow the gNB 102 to communicate with other gNBs through wired or wireless backhaul connections. When the gNB 102 is implemented as an access point, the backhaul or network interface 382 can allow the gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 may include an RAM, while another part of the memory 380 may include a flash memory or other ROMs. In certain embodiments, a plurality of instructions, such as the BIS algorithm, are stored in the memory. The plurality of instructions is configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, the gNB 102 may include any number of each component shown in FIG. 3A. As a specific example, the access point may include many backhaul or network interfaces 382, and the controller/processor 378 can support routing functions to route data between different network addresses. As another specific example, although shown as including a single instance of the TX processing circuit 374 and a single instance of the RX processing circuit 376, the gNB 102 may include multiple instances of each (such as one for each RF transceiver).

A time domain unit (also called time unit) in this application may be: an OFDM symbol, an OFDM symbol group (composed of multiple OFDM symbols), a slot, a slot group (composed of multiple slots), a subframe, a subframe group (composed of multiple subframes), a system frame and a system frame group (composed of multiple system frames); and it may also be an absolute time unit, such as 1 millisecond, 1 second, etc. A time unit may also be a combination of multiple granularities, such as N1 slots plus N2 OFDM symbols.

A time domain unit (also called time unit) in this application may be: an OFDM symbol, an OFDM symbol group (composed of multiple OFDM symbols), a slot, a slot group (composed of multiple slots), a subframe, a subframe group (composed of multiple subframes), a system frame and a system frame group (composed of multiple system frames); and it may also be an absolute time unit, such as 1 millisecond, 1 second, etc. A time unit may also be a combination of multiple granularities, such as N1 slots plus N2 OFDM symbols.

A frequency domain unit (also called frequency unit) in this application may be: a subcarrier, a subcarrier group (composed of multiple subcarriers), a resource block (RB), which may also be called a physical resource block (PRB), a resource block group (composed of multiple RBs), a bandwidth part (BWP), a BWP group (composed of multiple BWPs), a frequency band/carrier, a frequency band/carrier group; and it may also be an absolute frequency domain unit, such as 1 Hz, 1 kHz, etc. A frequency domain unit may also be a combination of multiple granularities, such as M1 PRBs plus M2 subcarriers. In the present disclosure, in order to simplify the description, a carrier and a positioning frequency layer (PFL) can refer to or be replaced by each other. For example, a reference to carrier may include a reference to a PFL and/or a carrier, and the reference to PFL may also include the reference to PFL and/or carrier. In the present disclosure, any method that applies to carriers may also apply to PFLs, and any method that applies to PFLs may also apply to carriers. In addition, in the present disclosure, carrier, subcarrier, component carrier and the like, may also refer to or be replaced by each other.

The exemplary embodiments of the present disclosure are further described below in conjunction with the accompanying drawings.

The text and drawings are provided as examples only to help readers understand the present disclosure. They are not intended and should not be interpreted as limiting the scope of the present disclosure in any way. Although certain embodiments and examples have been provided, based on the content disclosed herein, it is obvious to those skilled in the art that modifications to the illustrated embodiments and examples can be made without departing from the scope of the present disclosure.

Transmission link of a wireless communication system mainly includes: a downlink from a 5G new radio (NR) gNB to a user equipment (UE), an uplink from a UE to the network, and a sidelink (SL) from a UE to a UE, which may also be called a sidelink, etc.

In a wireless communication system (e.g., the current wireless communication system), nodes for positioning measurement may include: a UE issuing a positioning request message, a location management function (LMF) used for UE positioning and for positioning assistance data transmission, a gNB or transmission-reception point (TRP) used to broadcast positioning assistance data and perform uplink positioning measurements, and a UE used to perform downlink positioning measurements.

In order to further improve the positioning accuracy, bandwidth aggregation of a positioning reference signal is provided to achieve a measurement of a positioning reference signal of a large bandwidth. For a downlink reference signal (e.g., PRS) for positioning, a UE may be configured with one or more positioning frequency layers (PFLs), and reference signal resources for positioning in the same positioning frequency layer may be configured with common configuration parameters, such as the same subcarrier spacing, bandwidth, starting physical resource block (PRB), starting point (PointA), comb size N and cyclic prefix. Each positioning frequency layer may be configured with one or more TRPs, and one or more positioning reference signal resource sets may be configured under each TRP. For an uplink reference signal (e.g., SRS) for positioning, a UE may transmit SRS within an uplink bandwidth part (BWP).

For example, the UE may transmit SRS within an active UL BWP in an RRC connected state, and/or the UE may transmit SRS within an initial UL BWP or outside the initial UL BWP in an RRC inactive state, where SRS resources transmitted outside the initial UL BWP are configured in the same frequency band and/or carrier as the initial UL BWP. Currently, for the enhancement of the measurement of a positioning reference signal, when a total power of a positioning reference signal across aggregated carriers exceeds limitation of a maximum power, how to aggregate carriers or transmit the positioning reference signal is a problem that needs to be solved.

Specifically, in the present disclosure, a method and device for measuring a positioning reference signal across aggregated PFLs and/or carriers are provided. More specifically, in embodiments of the present disclosure, a method for determining power control parameters on aggregated carriers, and a method for aggregating carriers when a total power of an uplink positioning reference signal on aggregated carriers exceeds limitation of a maximum power is disclosed. In the present disclosure, exemplary methods are described by using a positioning reference signal (PRS) and/or a sounding reference signal (SRS) as non-limiting examples of reference signals for positioning. The described methods may also be used for reception of other signals and/or channels, for example, physical downlink shared channels (PDSCHs), and/or physical downlink control channels (PDCCHs), and/or physical broadcast channels (PBCHs), and/or channel state information reference signals (CSI-RSs), and/or demodulation reference signals (DMRSs).

A method for a UE to enable a measurement across aggregated PFLs and/or carriers (which may also be referred to as aggregation measurement for short herein) and/or to transmit a positioning reference signal may include a combination of one or more of the following:
The UE performs a measurement and/or transmission of a reference signal for positioning (for example, SRS and/or PRS, etc., which may be referred to as first signal herein) across aggregated PFLs and/or carriers and/or acquires configuration information of the reference signal for positioning by receiving radio resource control (RRC) messages (periodically);
The UE can be activated and/or deactivated with a measurement and/or transmission of a reference signal for positioning (for example, SRS and/or PRS, etc., which may be referred to as first signal herein) across aggregated PFLs and/or carriers and acquires configuration information for aggregation measurement of the reference signal for positioning by receiving radio resource control (RRC) messages and/or media access control (MAC) control element (CE) messages and/or downlink control information (DCI);
The UE is dynamically indicated with time-frequency resource locations of and/or configuration information of resources or resource sets of SRS and/or PRS across aggregated PFLs and/or carriers by receiving downlink control information (DCI). Alternatively, the UE acquires the resource locations for performing aggregation measurement of the reference signal for positioning across aggregated PFLs and/or carriers by receiving DCI format 1_0 and/or DCI format 1_1 and/or DCI format 1_2. Herein, time domain resource allocation (TDRA) is used to determine the resource location of time domain aggregation, and frequency domain resource allocation (FDRA) is used to determine the resource location of frequency domain aggregation;
The configuration information for aggregation measurement of the reference signal for positioning (which, herein, may also be referred to as bandwidth aggregation of a positioning reference signal, or bandwidth aggregation of a first signal) may include at least one of the following: the period for the UE to perform the measurement across aggregated PFLs and/or carriers; the starting time unit of the measurement across aggregated PFLs and/or carriers; the duration of a single aggregation measurement in time domain; the port index of the aggregation measurement, the number and/or indexes and/or starting frequency units of PFLs and/or carriers for the aggregation measurement; reference PFLs and/or carriers for the aggregation measurement; indexes of the reference PFLs and/or carriers for the aggregation measurement and/or the starting frequency units and/or the quasi-co-location (QCL) relationships and/or the spatial relationships and/or the resource element offsets (RE offsets); and, the first power threshold Pmax of SRS across aggregated carriers;
the UE may be instructed of the first information related to aggregation measurement via long term evolution (LTE) positioning protocol (LPP) messages sent from LMF, such as PRS assistance data or user location information request messages, so that the LMF and UE have the same understanding of the first information;
The UE notifies a base station of first information related to the aggregation measurement which is expected by the UE through RRC messages (such as LocationMeasurementInfo), so that the base station configures a corresponding reference signal for positioning with reference to the requirement of the UE;
The base station notifies the LMF of first information related to the aggregation measurement through new radio (NR) positioning protocol A (NRPPa) messages, so that the LMF and the base station have the same understanding of the first information; and
The first information may include at least one of the following: the number and/or indexes of PFLs and/or carriers for the aggregation measurement when the UE measures PRS across aggregated PFLs and/or carriers; the number and/or indexes of carriers for the aggregation measurement when a base station measures SRS across aggregated PFLs and/or carriers; indexes of referenced PFLs and/or carriers and/or the starting frequency units and/or the quasi-co-location (QCL) relationships and/or the spatial relationships when performing the aggregation measurement across PFLs and/or carriers; a starting point and/or duration of the aggregation measurement; and, PFLs and/or carriers referenced when performing the aggregation measurement.

When measuring reference signals for positioning by using continuous aggregated carriers, a method for ensuring continuity of resource patterns of the reference signals for positioning across aggregated PFLs and/or carriers may include a combination of one or more of the following:
When first symbols of PRS and/or SRS resources configured on more than one aggregated PFL and/or carrier have inconsistent starting resource element offsets (starting RE offsets) in frequency, the more than one aggregated PFL and/or carrier does not apply the configured starting RE offsets, and/or applies a starting RE offset of a reference PFL and/or carrier;
When there are N guard subcarrier spacings (guard tones) between more than one aggregated PFL and/or carrier, N is a predefined or preconfigured frequency unit parameter value and is greater than or equal to 1; and, in order to ensure the continuity of resource patterns of the reference signals for positioning on PFLs and/or carriers, a frequency domain starting physical resource block (startPRB) of the aggregated PFLs and/or carriers may be, the configured startPRB of the PFLs and/or carriers plus the number N of the guard tones and then taking remainder of a configured comb size of the PRS and/or SRS; and
When more than one aggregated PFL and/or carrier has different starting points pointA, a UE uses the pointA of a reference PFL and/or carrier as the pointA of all the aggregated PFLs and/or carriers. The UE recalculates the startPRB of the reference signals for positioning configured in a single PFL and/or carrier based on the newly determined pointA. When any two PFLs and/or carriers among the aggregated PFLs and/or carriers overlap in frequency domain, the startPRB of the PFL and/or carrier with a high carrier frequency at the overlap is recalculated as a frequency unit after removing the overlapping subcarriers plus a number M of the overlapping subcarriers and then taking remainder of the configured comb size of the PRS and/or SRS, or, the startPRB of the PFL and/or carrier with a high carrier frequency at the overlap is recalculated as a frequency unit after removing the overlapping subcarriers plus a number M of the overlapping subcarriers and then taking remainder of the subcarrier number 12 of a PRB. The overlap in frequency domain means that the end position (startPRB+the end position of the configured carrier or a first signal bandwidth) of one PFL and/or carrier in frequency domain is greater than the start position (that is, startPRB) of another PFL and/or carrier. Herein, M is greater than or equal to 1.

When measuring reference signals for positioning by using continuous aggregated carriers, a method for determining power control parameters P0, alpha and path loss reference signals on the aggregated carriers may include a combination of one or more of the following:
When SRS resources or resource sets configured on multiple aggregated carriers at the same time unit are inconsistent in power control parameters P0, alpha and path loss reference signals, the SRS resources or resource sets on the multiple aggregated carriers do not apply the power control parameters P0, alpha and the path loss reference signals of the SRS resources or resource sets configured currently for the carriers, and/or apply the power control parameters P0, alpha and/or the path loss reference signals of the SRS resources or resource sets configured for a reference carrier on the same time unit;
The path loss reference signals in SRS power control on aggregated carriers may be that: a SSB and/or CSI-RS and/or PRS with the maximum reference signal receiving power (RSRP) is selected as the path loss reference signal of SRS resources or resource sets across aggregated carriers on the same time unit based on the measurement of a downlink synchronization signal block (SSB) and/or CSI-RS and/or PRS of a serving cell; and
Predefined or preconfigured power control parameters are used, where alpha=1; and/or, P0 of SRS resources or resource sets across aggregated carriers is determined based on P0 of physical random access channels (PRACHs) configured in system information block 1 (SIB1). Alternatively, considering the power ramping mechanism used in random access channels, P0 of SRS resources or resource sets across aggregated carriers determined by the UE may be equal to P0 of a physical random access channel (PRACH) plus a predefined or preconfigured delta value, wherein the predefined or preconfigured delta value is a real number greater than or equal to 0.

When a total power for SRS transmission on aggregated carriers exceeds limitation of a maximum power (for example, a first power threshold), a method for a UE to determine aggregated carriers for SRS transmission may include a combination of one or more of the following:
The UE reduces the number of aggregation carriers for transmitting uplink positioning reference signals; and, by using a carrier aggregation priority principle, one or more carriers with a low priority are not expected to be aggregated or are dropped, until the SRS transmission power control limitation on aggregated carriers is met, that is, the total power for SRS transmission across carriers is less than the limitation of a maximum power. If the power on a last remaining carrier still exceeds the limitation of a maximum power, the UE does not expect to transmit or drops SRS resources or transmission;
Based on the power value on each carrier of the aggregated carriers, the UE does not expect to aggregate or drops a carrier the transmission power on which exceeds the limitation of a maximum power on a single carrier (e.g., a second power threshold) and/or the limitation of a maximum power on aggregated carriers, until the SRS transmission power control limitation on aggregated carriers is met, that is, the total power for SRS transmission across carriers is less than the limitation of a maximum power. If the power on a last remaining carrier still exceeds the limitation of a maximum power, the UE does not expect to transmit or drops SRS resources or transmission;
The UE uses a predefined or preconfigured parameter value P as a granularity to reduce the SRS transmission power across all aggregated carriers, until the SRS transmission power control limitation on aggregated carriers is met, that is, the total power for SRS transmission across carriers is less than limitation of a maximum power;
The UE uses a predefined or preconfigured parameter value P as a granularity to reduce the SRS transmission power on a part of the carriers, where selection of the part of the carriers may be determined according to a priority principle, that is, the SRS transmission power on one or more carriers with a low priority may be reduced; or, the part of the carriers may be carriers the transmission power on which exceeds the limitation of a maximum power on a single carrier and/or the limitation of a maximum power on aggregated carriers, until the SRS transmission power control limitation on aggregated carriers is met, that is, the total power for SRS transmission across carriers is less than limitation of a maximum power;
The carrier aggregation priority principle may include a combination of one or more of the following:
   In case that the SRS transmission power control limitation on aggregated carriers and/or the SRS transmission power control limitation on a single carrier is met, that is, the total power for SRS transmission across carriers and/or on a single carrier is less than limitation of a maximum power, the priority of continuous aggregated carriers is higher than the priority of a carrier with the largest single-carrier bandwidth among the aggregated carriers,
   The priority of a carrier with the largest single-carrier bandwidth among the aggregated carriers is higher than the priority of a configured or indicated reference carrier,
   The priority of a configured or indicated reference carrier is higher than the of other single-carriers and/or discontinuous carriers, and
   Priorities of other single-carriers and/or discontinuous carriers that do not contain the configured or indicated reference carrier is determined by their carrier bandwidths. The larger the carrier bandwidth, the higher the priority;
If the total power for SRS transmission on the aggregated carriers or the limitation of a maximum power across all the aggregated carriers is less than a preconfigured or predefined threshold or a threshold reported by a UE based on its own processing capability, the UE's behavior may include a combination of one or more of the following:
   The UE does not expect to transmit or drops SRS resources or transmissions, and
   The UE drops one or more carriers for SRS transmission; this method may be used to increase the transmission power on each resource element on the aggregated carriers and increase the probability of SRS being correctly received. Herein, transmission power on each resource element on the aggregated carriers is the same;
The dropping of one or more carriers for SRS transmission may be to drop one or more carriers at the edge of the continuous aggregated carriers to ensure that the remaining carriers are continuous, so that the UE may still transmit SRS in an aggregation manner;
The dropping of one or more carriers for SRS transmission may be to drop one or more carriers with small bandwidth in the continuous aggregated carriers to ensure that the remaining carriers have larger bandwidths, so as to improve the measurement accuracy of SRS;
The dropping of one or more carriers for SRS transmission may be to drop any one or more carriers except the configured or indicated reference carriers to improve the probability of SRS being correctly received or measured;
The dropping of one or more carriers for SRS transmission may be determined based on the carrier aggregation priority principle; and
Alternatively, if the UE drops one or more carriers for SRS transmission, the UE's behavior may include a combination of one or more of the following:
   If there is more than one carrier remaining and the more than one carrier is continuous in frequency domain (that is, other carriers except the dropped carriers have the number of more than one and are continuous carriers), the aggregation transmission of SRS is performed on the more than one carrier,
   If there is more than one carrier remaining and the more than one carrier is discontinuous in frequency domain (that is, other carriers except the dropped carriers have the number of more than one and are discontinuous carriers), a carrier with a larger bandwidth (that is, a carrier with a higher priority) is selected from the more than one carrier, for SRS transmission,
   If there is more than one carrier remaining and the more than one carrier is discontinuous in frequency domain and contains a configured or indicated reference carrier (that is, other carriers except the dropped carriers have the number of more than one and are discontinuous carriers and contain a configured or indicated reference carrier), a reference carrier or a carrier with the largest single-carrier bandwidth among the aggregated carriers is used for SRS transmission,
   If there is one carrier remaining, SRS is transmitted on the carrier in a single-carrier manner, and
   Notify a base station and/or LMF of first information of aggregated carriers through higher layer signaling or UCI or auxiliary information.

When the condition that the PRS across aggregated PFLs and/or carriers conflicts/collides with the first downlink signal is met, UE determines that the PRS across aggregated PFLs and/or carriers conflicts/collides with the first downlink signal; otherwise, the UE determines that the PRS across aggregated PFLs and/or carriers does not conflict/collide with the first downlink signal. When the condition that the SRS across aggregated PFLs and/or carriers conflicts/collides with the first downlink signal and/or the first uplink signal is met, the UE determines that the SRS across aggregated PFLs and/or carriers conflicts/collides with the first downlink signal and/or the first uplink signal; otherwise, the UE determines that the SRS across aggregated PFLs and/or carriers does not conflict/collide with the first downlink signal and/or the first uplink signal. Specifically, the condition that the PRS across aggregated PFLs and/or carriers conflicts/collides with the first downlink signal and/or the condition that the SRS across aggregated PFLs and/or carriers conflicts/collides with the first downlink signal and/or the first uplink signal include one or more of the following:
A partial and/or full overlap/collision occurs on a frequency domain unit of any one of the aggregated PFLs and/or carriers;
On the time domain unit of any one of the aggregated PFLs and/or carriers, a time interval between the end position of the first downlink signal and the start position corresponding to the latest PRS and/or SRS across aggregated PFLs and/or carriers is less than a threshold N1, and/or a time interval between the end position of the PRS and/or SRS across aggregated PFLs and/or carriers and the start position corresponding to the first downlink signal is less than a threshold N2. Or, on the time domain unit of any one of the aggregated PFLs and/or carriers, any part of the first downlink signal overlaps with a time interval starting from N1 OFDM symbols before the PRS and/or SRS resource occasion and ending in N2 OFDM symbols after the PRS and/or SRS resource occasion. Herein, N1 is a time unit value (reported by the UE) that meets the processing delay, switching/retuning delay and other time delays of the first downlink signal; N2 is the time unit value (reported by the UE) that meets the processing delay, switching/retuning delay and other time delays of PRS and/or SRS across aggregated PFLs and/or carriers; and, N1 and N2 are real numbers greater than or equal to 0, and may be of the same value;
On the time domain unit of any one of aggregated carriers, a time interval between the end position of the first uplink signal and the start position corresponding to the latest SRS across aggregated carriers is less than a threshold N3, and/or a time interval between the end position of the SRS across aggregated carriers and the starting position corresponding to the first uplink signal is less than a threshold N4. Or, on the time domain unit of any one of aggregated carriers, any part of the first uplink signal overlaps with a time interval starting from N3 OFDM symbols before the SRS resource occasion and ending in N4 OFDM symbols after the SRS resource occasion. Herein, N3 is a time unit value (reported by the UE) that meets the processing delay, switching/retuning delay and other time delays of the first uplink signal; N4 is a time unit value (reported by the UE) that meets the processing delay, switching/retuning delay and other time delays of PRS and/or SRS across aggregated PFLs and/or carriers; and, N3 and N4 are real numbers greater than or equal to 0, and may be of the same value;
The first downlink signal includes at least one of the following: SSB, physical downlink control channel (PDCCH) and/or physical downlink shared channel (PDSCH) for scheduling and/or transmitting SIB, PDCCH and/or PDSCH for scheduling and/or transmitting control resource set 0 (CORESET0), PDCCH and/or PDSCH for scheduling and/or transmitting message 2 (MSG2)/message B (MSG B), PDCCH and/or PDSCH for scheduling and/or transmitting paging, and PDCCH and/or PDSCH for scheduling and/or transmitting downlink small data transmission (DL SDT) signals;
The first uplink signal includes at least one of the following: valid random access occasion (valid RO) in a random access procedure (RA procedure), physical uplink shared channel (PUSCH) (and/or repeated transmission of PUSCH) for message 3 (msg3), physical uplink control channel (PUCCH) for message 4 (msg4), high-priority or low-priority PUCCH transmission (and/or repeated transmission of PUCCH), high-priority or low-priority PUSCH transmission (and/or repeated transmission of PUSCH), and sounding reference signal (SRS); and
The N1, N2, N3, and N4 can be parameter values (pre) configured or predefined by a base station equipment and/or reported by the UE based on its own processing capability (when the threshold parameter values configured by the base station equipment are not provided). Preferably, when comparing a time (and/or frequency domain) interval between the first downlink signal and/or the first uplink signal and the PRS and/or SRS with a first threshold, the first downlink signal and/or the first uplink signal may be replaced by the starting position or the end position of the time unit (and/or frequency domain unit) where the first downlink signal and/or the first uplink signal is located; and, the PRS and/or SRS may be replaced by the start position or end position of the time unit (and/or frequency domain unit) where the PRS and/or SRS is located.

The priority relationship between PRS and/or SRS across aggregated PFLs and/or carriers and all or part of the first uplink signal and/or the first downlink signal may include a combination of one or more of the following:
Based on UE's capability and/or base station's indications and/or UE's capability, the priority of the PRS and/or SRS across aggregated PFLs and/or carriers is higher than the priority of all or part of the first uplink signal and/or the first downlink signal. When reception or measurement of the PRS across aggregated PFLs and/or carriers collides with all or part of the first downlink signal, the UE expects to measure the PRS across aggregated PFLs and/or carriers, and/or does not expect to receive symbols or resources (or transmissions) of all or part of the first downlink signal. When SRS transmission across aggregated carriers collides with all or part of the first uplink signal and/or the first downlink signal, the UE expects to transmit the SRS across aggregated carriers, and/or does not expect to receive symbols or resources (or transmissions) of all or part of the first uplink signal and/or the first downlink signal;
Based on UE's capability and/or base station's indications and/or UE's capability, the priority of the PRS and/or SRS across aggregated PFLs and/or carriers is lower than the priority of all or part of the first uplink signal and/or the first downlink signal. In this case, the UE's behavior may include a combination of one or more of the following:
   When reception or measurement of the PRS across aggregated PFLs and/or carriers collides with the all or part of the first downlink signal, the UE expects to receive the all or part of the first downlink signal on the carriers where collision occurs, and/or does not expect to measure or drops PRS symbols or resources (or transmissions) colliding with the first downlink signal on the PFLs and/or carriers where collision occurs,
   When reception or measurement of the PRS across aggregated PFLs and/or carriers collides with the all or part of the first downlink signal, the UE expects to receive the all or part of the first downlink signal on the carriers where collision occurs, and/or does not expect to measure or drops PRS symbols or resources (or transmissions) transmitted across all the aggregated PFLs and/or carriers,
   When SRS transmission across aggregated carriers collides with the all or part of the first uplink signal and/or the first downlink signal, the UE expects to receive the all or part of the first downlink signal and/or transmit the first uplink signal on the carriers where collision occurs, and/or does not expect to transmit or drops SRS symbols or resources (or transmissions) which are transmitted on the carriers where collision occurs and colliding with the first downlink signal and/or the first uplink signal,
   When SRS transmission across aggregated carriers collides with the all or part of the first uplink signal and/or the first downlink signal, the UE expects to receive the all or part of the first downlink signal and/or transmit the first uplink signal on the carriers where collision occurs, and/or does not expect to transmit or drops SRS symbols or resources (or transmissions) transmitted across all the aggregated carriers,
   Alternatively, if the PFLs and/or carriers where no collision occurs are continuous, the UE expects to transmit SRS and/or measure PRS symbols or resources (or transmission) on one or multiple continuous PFLs and/or carriers where no collision occurs, and if the PFLs and/or carriers where no collision occurs are discontinuous, the UE expects to transmit SRS and/or measure PRS symbols or resources (or transmission) on any one of the PFLs and/or carriers where no collision occurs,
   Alternatively, if the UE drops PRS symbols colliding with the first downlink signal on the PFLs and/or carriers where collision occurs, and/or drops SRS symbols colliding with the first downlink signal and/or the first uplink signal on the carriers where collision occurs, the UE performs aggregation measurement or receives PRS and/or transmits SRS symbols or resources (or transmissions) on time domain units where no collision occurs, and
   When reception or measurement of the PRS across aggregated PFLs and/or carriers collides with the all or part of the first downlink signal, and/or when SRS transmission across aggregated carriers collides with the all or part of the first uplink signal and/or the first downlink signal, the UE determines the first information such as the indexes of the aggregated carriers and/or the starting point and/or duration of the aggregation, and notifies the base station and/or LMF of changes of the first information through higher layer signaling or UCI or auxiliary information; and
Alternatively, if the UE drops SRS symbols or resources or transmissions on one or more carriers for SRS transmission and/or PRS symbols or resources or transmissions on one or more carriers for PRS reception due to PRS/SRS's collision with the first downlink signal and/or the first uplink signal, the UE's behavior may include a combination of one or more of the following:
   If there is more than one carrier remaining and the more than one carrier is continuous in frequency domain, aggregation transmission of SRS and/or aggregation reception of PRS is performed on the more than one carrier,
   If there is more than one carrier remaining and the more than one carrier is discontinuous in frequency domain, then a carrier with a larger carrier bandwidth is selected from the more than one carrier and/or a carrier with a higher priority is selected from the more than one carrier, for SRS transmission and/or receiving PRS,
   If there is more than one carrier remaining and the more than one carrier is discontinuous in frequency domain and contains a configured or indicated reference carrier, the reference carrier or a carrier with the largest single-carrier bandwidth among the aggregated carriers are used to transmit SRS and/or receive PRS,
   If there is one carrier remaining, the SRS is transmitted and/or the PRS is received on the carrier in a single-carrier manner,
   If there is more than one carrier remaining, and a ratio of a sum of the bandwidth of the more than one carrier to the bandwidth of all the configured or indicated aggregated carriers is greater than a predefined or preconfigured threshold, then aggregation transmission of SRS and/or aggregation reception of PRS is performed on the more than one carrier,
   If there is more than one carrier remaining, and a ratio of the bandwidth of carriers with a larger bandwidth among the more than one carrier to the bandwidth of all the configured or indicated aggregated carriers is greater than a predefined or preconfigured threshold, then aggregation transmission of SRS and/or aggregation reception of PRS is performed on the carriers with a larger bandwidth,
   If there is one carrier remaining, and a ratio of the bandwidth of the carrier to the bandwidth of all the configured or indicated aggregated carriers is greater than a predefined or preconfigured threshold, then aggregation transmission of SRS and/or aggregation reception of PRS is performed on the carrier in a single-carrier manner,
   SRS symbols or resources or transmissions colliding with the all or part of the first downlink signal and/or the first uplink signal are dropped or are not transmitted across all the aggregated carriers, and/or PRS symbols or resources or transmissions colliding with the all or part of the first downlink signal and/or the first uplink signal are not received or not measured across all the aggregated carriers. Alternatively, if there is more than one carrier remaining and the more than one carrier is discontinuous in frequency domain, SRS symbols or resources or transmissions colliding with the all or part of the first downlink signal and/or the first uplink signal are dropped or are not transmitted across all the aggregated carriers, and/or PRS symbols or resources or transmissions colliding with the all or part of the first downlink signal and/or the first uplink signal are not received or not measured across all the aggregated carriers,
   Notify the base station and/or LMF of first information of aggregated carriers through higher layer signaling or UCI or auxiliary information, and
   Notify the base station and/or LMF first information of one or more carriers for SRS transmission and/or carriers for PRS reception which are dropped through higher layer signaling or UCI or auxiliary information.

When measuring PRS across continuous aggregated PFLs and/or carriers, if the PRS collides with the first downlink signal and/or channel on any carrier, and the PRS has a low priority, then the UE's behavior may include a combination of one or more of the following:
If a time interval between a time unit and/or frequency unit when decoding of scheduling indication information for the first downlink signal is completed or when the scheduling indication information for the first downlink signal is received and a starting position of PRS across aggregated PFLs and/or carriers and/or a starting position of DRX cycle is less than or not greater than a first threshold N5, then the UE determines the priority of the current PRS across aggregated PFLs and/or carriers as a high priority or changes the priority of the current PRS across aggregated PFLs and/or carriers to a high priority; in this case, the UE expects to receive or measure the PRS across aggregated PFLs and/or carriers, and/or not to receive or drop symbols or resources (or transmissions) of the first downlink signal;
If after Y1 time units before the starting position of the PRS across aggregated PFLs and/or carriers and/or the starting position of DRX cycle, the UE determines that it expects to receive the first downlink signal or the first downlink signal scheduled/activated by DCI/MAC CE, then the UE determines the priority of the current PRS across aggregated PFLs and/or carriers as a high priority or changes the priority of the current PRS across aggregated PFLs and/or carriers to a high priority; in this case, the UE expects to receive or measure the PRS across aggregated PFLs and/or carriers, and/or not to receive or drop symbols or resources (or transmissions) of the first downlink signal;
The UE's behavior applies to situations where when the UE is preparing to perform aggregation measurement of PRS, the UE receives a first downlink signal/channel scheduled on a specific PFL, and the radio frequency end of the UE cannot timely change from receiving or measuring PRS transmitted on multiple PFLs to receiving the first downlink signal/channel on the specific PFL;
If a time interval between a time unit and/or frequency unit when decoding of scheduling indication information for the first downlink signal is completed or when the scheduling indication information for the first downlink signal is received and a starting position of PRS across aggregated PFLs and/or carriers and/or a starting position of DRX cycle is less than or not greater than a first threshold N5, or if after Y1 time units before the starting position of the PRS across aggregated PFLs and/or carriers and/or the starting position of DRX cycle, the UE determines that the UE expects to receive the first downlink signal or the first downlink signal scheduled/activated by DCI/MAC CE, then the UE expects to receive or measure symbols or resources (or transmissions) of the first downlink signal and/or the UE does not expect to receive or drops PRS transmissions and/or symbols across aggregated PFLs on symbols of all the aggregated PFLs where collision occurs, or drops PRS transmissions and/or symbols on symbols of PFLs where collision occurs, or the UE does not expect to receive or drops PRS transmissions and/or symbols on carriers where collision occurs; and
The N5 and Y1 can be parameter values (pre) configured or predefined by a base station equipment and/or reported by the UE based on its own processing capability (when the threshold parameter values configured by the base station equipment are not provided). Preferably, when comparing a time (and/or frequency domain) interval between the first downlink signal and/or the first uplink signal and the PRS and/or SRS with a first threshold, the first downlink signal and/or the first uplink signal may be replaced by the starting position or the end position of the time unit (and/or frequency domain unit) where the first downlink signal and/or the first uplink signal is located; and, the PRS and/or SRS may be replaced by the start position or end position of the time unit (and/or frequency domain unit) where the PRS and/or SRS is located.

When transmitting SRS across the aggregated carriers, if the SRS collides with the first downlink signal and/or the first uplink signal on any carrier, and if the SRS is determined as a low priority, the UE's behavior may include a combination of one or more of the following:
If a time interval between a time unit and/or frequency unit when decoding of scheduling indication information for the first downlink signal is completed or when the scheduling indication information for the first downlink signal is received and a starting position of SRS across aggregated carriers is less than or not greater than a second threshold N6, and/or if a time interval between a time unit and/or frequency unit when transmission of the first uplink signal is determined and a starting position of SRS across aggregated carriers is less than or not greater than a third threshold N7, then the UE determines the priority of the current SRS across aggregated carriers as a high priority or changes the priority of the current SRS across aggregated carriers to a high priority; in this case, the UE expects to transmit the SRS symbols or resources (or transmissions) across aggregated carriers, and/or not to receive or drop symbols or resources (or transmissions) of the first downlink signal and/or not to transmit the symbols or resources (or transmissions) of the first uplink signal;
If after Y2 time units before the starting position of the SRS across the aggregated carriers, the UE determines that the UE expects to receive the first downlink signal or the first downlink signal scheduled/activated by DCI/MAC CE and/or transmit the first uplink signal, then the UE determines the priority of the current SRS across aggregated carriers as a high priority or changes the priority of the current SRS across aggregated carriers to a high priority; in this case, the UE expects to transmit the SRS across aggregated carriers and/or not to receive or drop symbols or resources (or transmissions) of the first downlink signal and/or transmit symbols or resources (or transmissions) of the first uplink signal;
The UE's behavior applies to situations where when the UE is preparing to perform aggregation transmission of SRS, the UE receives a first downlink signal/channel and/or a first uplink signal scheduled on a specific carrier, and the radio frequency end of the UE cannot timely change from transmitting the SRS on multiple carriers to receiving the first downlink signal and/or transmitting the first uplink signal on the specific carrier;
If after Y2 time units before the starting position of the SRS across the aggregated carriers, the UE determines that the UE expects to receive the first downlink signal or the first downlink signal scheduled/activated by DCI/MAC CE and/or transmit the first uplink signal, or if a time interval between a time unit and/or frequency unit when decoding of scheduling indication information for the first downlink signal is completed or when the scheduling indication information for the first downlink signal is received and a starting position of SRS across aggregated carriers is less than or not greater than a second threshold N6, and/or if a time interval between a time unit and/or frequency unit when transmission of the first uplink signal is determined and a starting position of SRS across aggregated carriers is less than or not greater than a third threshold N7, the UE determines that the UE expects to receive the first downlink signal or the first downlink signal scheduled/activated by DCI/MAC CE and/or transmit the first uplink signal, then the UE drop SRS transmissions for positioning on symbols of all the aggregated carriers where collision occurs, or the UE does not expect to transmit or drop SRS transmissions and/or symbols for positioning across all the aggregated carriers where collision occurs, or drop SRS transmissions for positioning on symbols of the carrier where collision occurs, or the UE does not expect to transmit or drop SRS transmissions and/or symbols for positioning on the carrier where collision occurs; and
The N6, N7, and Y2 can be parameter values (pre) configured or predefined by a base station equipment and/or reported by the UE based on its own processing capability (when the threshold parameter values configured by the base station equipment are not provided).

When a receiving end uses a method for positioning based on carrier phases to measure the PRS and/or SRS, the receiving end reports a multipath indication signal (for example, a multipath indicator) to a transmitting end, for determining whether signals for positioning reference signal measurements and/or measurement result calculations are propagated through multiple paths or a single path. As a non-limiting example, a method for determining whether a reference signal for positioning is propagated through multiple paths or a single path (a reference signal for positioning is a single-path signal or a propagation channel of a reference signal for positioning is a single-path channel) may include a combination of one or more of the following:
A fourth threshold L1 is set. When a difference between RSRPs of the reference signal for positioning received by the receiving end on a strongest path and a second strongest path is greater than the fourth threshold L1, the multipath indication signal is set to a specific value, for example but not limited to “0” or “false” (and in other implementations, it may be “1” or “true”), to indicate that the receiving end considers that the reference signals for positioning are propagated through a single path, where L1 may be a real number greater than 0; and
A fifth threshold L2 is set. When there are N paths on which RSRP values of the reference signal for positioning received by the receiving end are greater than the fifth threshold L2, the multipath indication signal is set to a specific value, for example but not limited to “0” or “false” (and in other implementations, it may be “1” or “true”), which indicates that the receiving end considers that the reference signal for positioning is propagated through a single path. Herein, L2 may be a real number greater than 0, and N may be an integer greater than or equal to 1. Alternatively, when there is one path on which the reference signal for positioning is received by the receiving end, N=1. Alternatively, when a time range during which the reference signal for positioning is received by the receiving end is less than a sixth threshold (within the same cluster), N is an integer greater than or equal to 1. In some implementations, when there are M paths or M clusters on which RSRP values of the reference signal for positioning received by the receiving end are greater than the fifth threshold L2 and M>N, the receiving end may consider that the reference signal for positioning is propagated through multiple paths, and may consider that the reference signal for positioning is propagated in a multipath environment. In this case, the multipath indication signal may be set to “1.”

For a frequency range 1 (FR1), the reference point for the carrier phases of reference signals for positioning and/or the reference point for the carrier phase differences of reference signals for positioning on each path may be the antenna connector at a receiving end and/or a transmitting end or the center of a given antenna array or an intersection of the bottom mounting surface and the central axis of an antenna. For a frequency range 2 (FR2), the reference point for the carrier phases of reference signals for positioning and/or the reference point for the carrier phase differences of reference signals for positioning on each path may be measured based on combined signals of antenna elements corresponding to a given receiver branch or the center position of a given receiver branch or a center beam direction of a given receiver branch.

For power control parameters for SRS for positioning configured by a UE in an RRC_INACTIVE state in multiple cells such as within a valid area, when a path loss reference signal is provided in the configuration, at least a cell-defined SSB may be configured as the path loss reference signal. If multiple path loss reference signals may be configured and no path loss reference signal field is configured, the UE uses a cell-defined SSB as the reference signal.

By receiving higher layer configuration parameters, such as RRC parameters, the UE determines an aggregation relationship of PRS resources or resource sets on multiple PFLs aggregated on one TRP, and/or an aggregation relationship of SRS resources or resource sets on multiple carriers aggregated on one TRP. By receiving a higher layer parameter for requesting aggregation, such as an RRC parameter, the UE determines an aggregation relationship of PRS resources or resource sets on multiple PFLs aggregated on one TRP during a measurement process and/or an aggregation relationship of SRS resources or resource sets on multiple carriers aggregated on one TRP during a measurement process. The aggregation relationship may include a combination of one or more of the following:
PRS resources and/or resource sets which meet the aggregation condition and are configured on multiple PFLs associated with one TRP, and/or SRS resources and/or resource sets configured on multiple carriers, may be combined arbitrarily, that is, PRS resources and/or resource sets configured on any aggregated PFL associated with one TRP and PRS resources and/or resource sets configured on other aggregated PFLs may form aggregated resources and/or resource sets through resource indexes and/or resource set indexes, and SRS resources and/or resource sets configured on any aggregated carrier and any one or more SRS resources and/or resource sets configured on other aggregated carriers may form aggregated resources and/or resources through resource indexes and/or resource set indexes, for cross-carrier aggregation measurement. Any PRS resource and/or resource set on the same PFL associated with one TRP and/or any SRS resource and/or resource set on the same carrier associated with one TRP may appear in different combinations. The same PFL and/or carrier associated with one TRP may be configured in different PFL and/or carrier aggregation combinations. On the same time unit, the combination is of a determined aggregation relationship, and the different combinations may be configured or measured on different time units;
The same PRS resource and/or resource set which meets the aggregation condition and is configured on multiple PFLs associated with one TRP, and/or the same SRS resource and/or resource set configured on multiple carriers, may only be expected to be configured and/or be requested to be aggregated in one combination, and/or cannot be expected to appear in different combinations, that is, any one PRS resource and/or resource set on the same PFL and/or any one SRS resource and/or resource set on the same carrier can only be expected to be configured or be measured aggregately in one combination, for cross-carrier aggregation measurement. The same PFL and/or carrier may be configured in different combinations of PFL and/or carrier aggregation. On the same time unit, the combination is of a determined aggregation relationship, and the different combinations may be configured or measured on different time units;
PRS resources and/or resource sets which meet the aggregation condition and are configured on the same PFL associated with one TRP and/or SRS resources and/or resource sets which meet the aggregation condition and are configured on the same carrier associated with one TRP cannot be expected to be configured and/or be requested to be measured in different combinations of PFL and/or carrier aggregation. Since both aggregation configuration and measurement request are higher layer parameter indications, the UE does not expect that different combinations of PFL and/or carrier aggregation are configured and/or requested to be measured on different time units. On the same time unit, the combination is of a determined aggregation relationship. Alternatively, PRS resources and/or resource sets which meet the aggregation condition and are configured on the same PFL associated with one TRP and/or SRS resources and/or resource sets which meet the aggregation condition and are configured on the same carrier associated with one TRP cannot be expected to be configured in different combinations of PFL and/or carrier aggregation, and/or can be requested to be measured in different combinations of PFL and/or carrier aggregation. This operation aims to avoid larger measurement errors on any aggregated PLF and/or carrier due to too poor channel conditions during a measurement process, and therefore more flexible combinations of PFL and/or carrier aggregation are supported during a measurement process;
The combinations of PFL and/or carrier aggregation may be combinations of PRS resources and/or resource sets configured on PFLs and/or SRS resources and/or resource sets configured on carriers; and
The aggregation condition is to have the same configuration parameters. For the linked PRS resource sets, the configuration parameters may include at least one of the following: QCL, period, ResourceSetSlotOffset, PRS NumSymbols, PRSResourceTimeGap, PRSResourceRepetitionFactor, PRS ResourceSymbolOffset, PRS MutingBitRepetitionFactor, PRS CyclicPrefix, comb size, power on each subcarrier, MutingPattern and NR-dl-PRS-SFN0-Offset; and the UE is expected to be configured with PRS resources that maintain uniformly spaced DL PRS RE patterns within symbols on aggregated PRS positioning frequency layers. For the linked SRS resource sets, the configuration parameters may include at least one of the following: startPosition, nrofSymbols, periodicityAndOffset, slotOffset, alpha, p0, subcarrier spacing, CP and comb size; and the UE is expected to maintain phase continuity of SRS transmission.

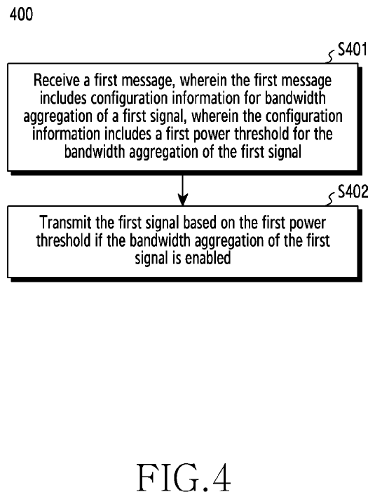

Next, FIG. 4 illustrates a flowchart of a method 400 performed by a user equipment in a wireless communication system according to various embodiments of the present disclosure.

As shown in FIG. 4, in Step S401, a UE may receive a first message (e.g., from a base station). In some implementations, the first message may include configuration information for bandwidth aggregation of a first signal. In some implementations, the configuration information for bandwidth aggregation of a first signal may also be determined by the UE itself. In some implementations, the configuration information for bandwidth aggregation of a first signal may include a first power threshold for the bandwidth aggregation of a first signal. In Step S402, if the bandwidth aggregation of the first signal is enabled, the UE may transmit the first signal (e.g., transmit to the base station) based on the first power threshold. As described above, the first signal may refer to a reference signal for positioning, such as SRS and PRS, etc. Furthermore, herein, the bandwidth aggregation or aggregation measurement may refer to a measurement of the reference signal for positioning across aggregated PFLs and/or carriers.

According to embodiments of the present disclosure, the first message further includes a bandwidth aggregation related indication for indicating whether to enable or activate the bandwidth aggregation of the first signal.

According to embodiments of the present disclosure, the transmitting the first signal based on the first power threshold comprises: when a total transmission power of the first signal exceeds the first power threshold, performing one or more of the following: dropping or not aggregating one or more carriers for transmitting the first signal; reducing transmission power for the first signal across all carriers of one or more carriers for transmitting the first signal; and reducing transmission power for the first signal on a part of one or more carriers for transmitting the first signal.

According to embodiments of the present disclosure, the one or more carriers dropped or not aggregated is/are carrier(s) with a low priority or carrier(s) on which transmission power exceeds a second power threshold.

According to embodiments of the present disclosure, the configuration information includes a number of the one or more carriers for transmitting the first signal and/or indexes of the one or more carriers for transmitting the first signal.

According to embodiments of the present disclosure, when performing the dropping or not aggregating one or more carriers for transmitting the first signal, the method further comprises one or more of the following: transmitting the first signal on more than one other continuous carrier; transmitting the first signal, on a carrier with the largest bandwidth and/or the highest priority among more than one other discontinuous carrier; when there is more than one other discontinuous carrier and the more than one other discontinuous carrier includes a reference carrier, transmitting the first signal on a carrier with the largest bandwidth or on the reference carrier; and transmitting the first signal on one carrier.

According to embodiments of the present disclosure, the method further comprises one or more of the following: determining power control parameters and/or path loss reference signals for transmitting the first signal based on configuration of a reference carrier; determining path loss reference signals for transmitting the first signal based on a reference signal with the maximum reference signal received power; and determining power control parameters for transmitting the first signal based on preconfigured power control parameters, wherein alpha=1, and/or P0 of the power control parameters for transmitting the first signal is determined according to a parameter P0 of a physical random access channel (PRACH) configured in a system information block 1 (SIB1).

According to embodiments of the present disclosure, the determining power control parameters and/or path loss reference signals for transmitting the first signal based on configuration of a reference carrier further comprises: determining the power control parameters and/or path loss reference signals for transmitting the first signal on the same time unit based on configuration of a reference carrier on the same time unit.

According to embodiments of the present disclosure, the method further comprises one or more of the following: a starting resource element offset of a first symbol of resources for transmitting and/or receiving the first signal is a starting resource element offset of a reference carrier; a starting resource element offset of a first symbol of resources for transmitting and/or receiving the first signal is: a starting physical resource block of a current carrier plus a number N of guard subcarrier spacings and then taking remainder of a configured comb size for the first signal, where N is greater than or equal to 1; a starting resource element offset of a first symbol of resources for transmitting and/or receiving the first signal is: a frequency unit after removing overlapping subcarriers in frequency domain from a starting physical resource block of a carrier with a high carrier frequency at an overlap, plus a number M of the overlapping subcarriers, and then taking remainder of a configured comb size for the first signal, where M is greater than or equal to 1; and a starting resource element offset of a first symbol of resources for transmitting and/or receiving the first signal is: a frequency unit after removing overlapping subcarriers in frequency domain from a starting physical resource block of a carrier with a high carrier frequency at an overlap, plus a number M of the overlapping subcarriers, and then taking remainder of a subcarrier number 12 for the first signal.

According to embodiments of the present disclosure, the bandwidth aggregation is a continuous bandwidth aggregation.

According to embodiments of the present disclosure, the method further comprises one or more of the following: when a priority of the first signal is higher than a priority of a first downlink signal and/or a first uplink signal, transmitting the first signal and not receiving or dropping symbols or resources (or transmission) of the first downlink signal and/or not transmitting symbols or resources (or transmission) of the first uplink signal; when a priority of the first signal is lower than a priority of a first downlink and/or a first uplink signal, dropping or not transmitting symbols or resources of the first signal conflicting with the first downlink signal and/or the first uplink signal on carriers where the conflicting occurs; and when a priority of the first signal is lower than a priority of a first downlink and/or a first uplink signal, dropping or not transmitting symbols or resources of the first signal across all carriers.

According to embodiments of the present disclosure, when a priority of the first signal is lower than a priority of a first downlink signal and/or a first uplink signal, the method further comprises one or more of the following: if an interval between a time unit and/or frequency unit when decoding of scheduling indication information for the first downlink signal is completed or when the scheduling indication information for the first downlink signal is received and a starting position for transmitting the first signal is less than or not greater than a second threshold, and/or, if an interval between a time unit and/or frequency unit when it is determined to transmit the first uplink signal and a starting position for transmitting the first signal is less than or not greater than a third threshold, the UE determines the priority of the first signal as a high priority; and if after a specific number of time units before a starting position for transmitting the first signal, the UE determines that the UE is expected to receive the first downlink signal and/or transmit the first uplink signal, then the UE determines the priority of the first signal as a high priority.

According to embodiments of the present disclosure, the first message is one or more of the following: a radio resource control (RRC) message, a media access control (MAC) control element (CE) message, and downlink control information (DCI).

According to embodiments of the present disclosure, the first signal is sounding reference signal (SRS) or positioning reference signal (PRS).

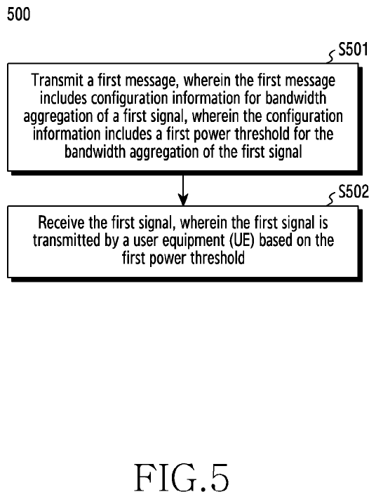

FIG. 5 illustrates a flowchart of a method 500 performed by a node in a wireless communication system according to various embodiments of the present disclosure.

As shown in FIG. 5, in Step S501, a node (for example, which may be a base station, etc.) may transmit a first message to a UE. In some implementations, the first message may include configuration information for bandwidth aggregation of a first signal. In some implementations, the configuration information for bandwidth aggregation of a first signal may also be determined by the UE itself In some implementations, the configuration information for bandwidth aggregation of a first signal may include a first power threshold for the bandwidth aggregation of a first signal. In Step S502, the base station may receive the first signal from the UE. In some implementations, the first signal may be transmitted to the base station by the UE when the bandwidth aggregation of the first signal is enabled. In some implementations, the first signal may be transmitted to the base station by the UE based on the first power threshold. As described above, the first signal may refer to a reference signal for positioning, such as SRS and PRS, etc. Furthermore, herein, the bandwidth aggregation or aggregation measurement may refer to a measurement of the reference signal for positioning across aggregated PFLs and/or carriers.

According to embodiments of the present disclosure, the first message further includes a bandwidth aggregation related indication for indicating whether to enable or activate the bandwidth aggregation of the first signal.

According to embodiments of the present disclosure, the configuration information includes a number of the one or more carriers for transmitting the first signal and/or indexes of the one or more carriers for transmitting the first signal.

According to embodiments of the present disclosure, the method further comprises: measuring the first signal according to a number of one or more carriers for the first signal and/or indexes of one or more carriers for the first signal received.

According to embodiments of the present disclosure, the method further comprises one or more of the following: receiving the first signal on more than one continuous carrier; receiving the first signal on a carrier with the largest bandwidth and/or the highest priority; receiving the first signal on a carrier with the largest bandwidth or on a reference carrier; and receiving the first signal on one carrier.

According to embodiments of the present disclosure, the method further comprises one or more of the following: determining power control parameters and/or path loss reference signals for the UE to transmit the first signal based on configuration of a reference carrier; determining path loss reference signals for the UE to transmit the first signal based on a reference signal with the maximum reference signal received power; and determining power control parameters for the UE to transmit the first signal based on preconfigured power control parameters, wherein alpha=1, and/or P0 of the power control parameters for transmitting the first signal is determined according to a parameter P0 of a physical random access channel (PRACH) configured in a system information block 1 (SIB1).

According to embodiments of the present disclosure, the determining power control parameters and/or path loss reference signals for the UE to transmit the first signal based on configuration of a reference carrier further comprises: determining the power control parameters and/or path loss reference signals for the UE to transmit the first signal based on configuration of a reference carrier on the same time unit.

According to embodiments of the present disclosure, the method further comprises one or more of the following: a starting resource element offset of a first symbol of resources of the first signal received is a starting resource element offset of a reference carrier; a starting resource element offset of a first symbol of resources of the first signal received is: a starting physical resource block of a current carrier plus a number N of guard subcarrier spacings and then taking remainder of a configured comb size for the first signal, where N is greater than or equal to 1; a starting resource element offset of a first symbol of resources of the first signal received is: a frequency unit after removing overlapping subcarriers in frequency domain from a starting physical resource block of a carrier with a high carrier frequency at an overlap, plus a number M of the overlapping subcarriers, and then taking remainder of a configured comb size for the first signal, where M is greater than or equal to 1; and a starting resource element offset of a first symbol of resources of the first signal received is: a frequency unit after removing overlapping subcarriers in frequency domain from a starting physical resource block of a carrier with a high carrier frequency at an overlap, plus a number M of the overlapping subcarriers, and then taking remainder of a subcarrier number 12 for the first signal.

According to embodiments of the present disclosure, the bandwidth aggregation is a continuous bandwidth aggregation.

According to embodiments of the present disclosure, the method further comprises one or more of the following: when a priority of the first signal is higher than a priority of a first downlink signal and/or a first uplink signal, receiving the first signal and not transmitting the first downlink signal and/or not receiving the first uplink signal; when a priority of the first signal is lower than a priority of a first downlink and/or a first uplink signal, dropping or not receiving symbols or resources of the first signal conflicting with the first downlink signal and/or the first uplink signal on carriers where the conflicting occurs; and when a priority of the first signal is lower than a priority of a first downlink and/or a first uplink signal, dropping or not receiving symbols or resources of the first signal across all carriers.

According to embodiments of the present disclosure, when a priority of the first signal is lower than a priority of a first downlink signal and/or a first uplink signal, the UE performs one or more of the following: if an interval between a time unit and/or frequency unit when decoding of scheduling indication information for the first downlink signal is completed or when the scheduling indication information for the first downlink signal is received and a starting position for transmitting the first signal is less than or not greater than a second threshold, and/or, if an interval between a time unit and/or frequency unit when it is determined to transmit the first uplink signal and a starting position for transmitting the first signal is less than or not greater than a third threshold, the UE determines the priority of the first signal as a high priority; and if after a specific number of time units before a starting position for transmitting the first signal, the UE determines that the UE is expected to receive the first downlink signal and/or transmit the first uplink signal, then the UE determines the priority of the first signal as a high priority.

According to embodiments of the present disclosure, the first message is one or more of the following: a radio resource control (RRC) message, a media access control (MAC) control element (CE) message, and downlink control information (DCI).

According to embodiments of the present disclosure, the first signal is sounding reference signal (SRS) or positioning reference signal (PRS).

It should be understood that the methods 400 and 500 according to embodiments of the present disclosure may also include any combination of any method or step as described above in connection with embodiments of the present disclosure.

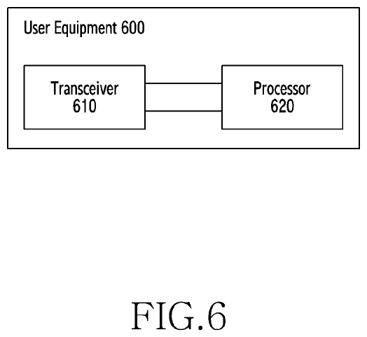

Next, FIG. 6 illustrates a user equipment 600 in a wireless communication system according to various embodiments of the present disclosure.

As shown in FIG. 6, a user equipment 600 according to embodiments of the present disclosure may include a transceiver 610 and a processor 620. The transceiver 610 may be configured to transmit and receive signals. The processor 620 may be coupled to the transceiver 610 and may be configured to (e.g., control the transceiver 610 to) perform any method performed by a user equipment in a wireless communication system according to embodiments of the present disclosure.

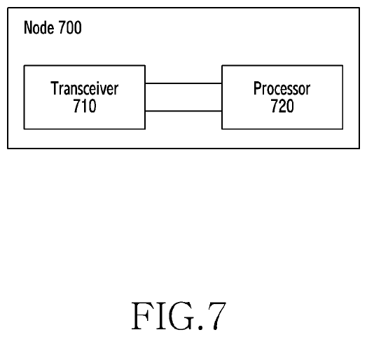

FIG. 7 illustrates a node 700 in a wireless communication system according to various embodiments of the present disclosure.

As shown in FIG. 7, a node 700 (e.g., a base station, etc.) according to embodiments of the present disclosure may include a transceiver 710 and a processor 720. The transceiver 710 may be configured to transmit and receive signals. The processor 720 may be coupled with the transceiver 710 and may be configured to (e.g., control the transceiver 710 to) perform any method performed by a node according to embodiments of the present disclosure. Herein, a processor may also be called a controller.

In an embodiment of the present disclosure, a method performed by a user equipment (UE) in a wireless communication system, comprising: receiving a first message, wherein the first message includes configuration information for bandwidth aggregation of a first signal, wherein the configuration information includes a first power threshold for the bandwidth aggregation of the first signal; and transmitting the first signal based on the first power threshold if the bandwidth aggregation of the first signal is enabled.

In an embodiment of the present disclosure, wherein the first message further includes a bandwidth aggregation related indication for indicating whether to enable or activate the bandwidth aggregation of the first signal.

In an embodiment of the present disclosure, wherein the transmitting the first signal based on the first power threshold comprises: when a total transmission power of the first signal exceeds the first power threshold, performing one or more of the following: dropping or not aggregating one or more carriers for transmitting the first signal; reducing transmission power for the first signal across all carriers for transmitting the first signal; and reducing transmission power for the first signal on a part of one or more carriers for transmitting the first signal.

In an embodiment of the present disclosure, wherein the configuration information includes a number of the one or more carriers for transmitting the first signal and/or indexes of the one or more carriers for transmitting the first signal.

In an embodiment of the present disclosure, wherein when performing the dropping or not aggregating one or more carriers for transmitting the first signal, the method further comprises one or more of the following: transmitting the first signal on more than one other continuous carrier; transmitting the first signal, on a carrier with the largest bandwidth and/or the highest priority among more than one other discontinuous carrier; when there is more than one other discontinuous carrier and the more than one other discontinuous carrier includes a reference carrier, transmitting the first signal on a carrier with the largest bandwidth or on the reference carrier; and transmitting the first signal on one carrier.

In an embodiment of the present disclosure, wherein the method further comprises one or more of the following: determining power control parameters and/or path loss reference signals for transmitting the first signal based on configuration of a reference carrier; determining path loss reference signals for transmitting the first signal based on a reference signal with the maximum reference signal received power; and determining power control parameters for transmitting the first signal based on preconfigured power control parameters, wherein alpha=1, and/or P0 of the power control parameters for transmitting the first signal is determined according to a parameter P0 of a physical random access channel (PRACH) configured in a system information block 1 (SIB1).

In an embodiment of the present disclosure, wherein the determining power control parameters and/or path loss reference signals for transmitting the first signal based on configuration of a reference carrier further comprises: determining the power control parameters and/or path loss reference signals for transmitting the first signal based on configuration of a reference carrier on the same time unit.

In an embodiment of the present disclosure, wherein the method further comprises one or more of the following: a starting resource element offset of a first symbol of resources for transmitting and/or receiving the first signal is a starting resource element offset of a reference carrier; a starting resource element offset of a first symbol of resources for transmitting and/or receiving the first signal is: a starting physical resource block of a current carrier plus a number N of guard subcarrier spacings and then taking remainder of a configured comb size for the first signal, where N is greater than or equal to 1; a starting resource element offset of a first symbol of resources for transmitting and/or receiving the first signal is: a frequency unit after removing overlapping subcarriers in frequency domain from a starting physical resource block of a PFL and/or carrier with a high carrier frequency at an overlap, plus a number M of the overlapping subcarriers, and then taking remainder of a configured comb size for the first signal, where M is greater than or equal to 1; and a starting resource element offset of a first symbol of resources for transmitting and/or receiving the first signal is: a frequency unit after removing overlapping subcarriers in frequency domain from a starting physical resource block of a PFL and/or carrier with a high carrier frequency at an overlap, plus a number M of the overlapping subcarriers, and then taking remainder of a subcarrier number 12 for the first signal.

In an embodiment of the present disclosure, wherein the method further comprises one or more of the following: when a priority of the first signal is higher than a priority of a first downlink signal and/or a first uplink signal, transmitting the first signal and not receiving symbols or resources of the first downlink signal and/or not transmitting symbols or resources of the first uplink signal; when a priority of the first signal is lower than a priority of a first downlink and/or a first uplink signal, dropping or not transmitting symbols or resources of the first signal conflicting with the first downlink signal and/or the first uplink signal on carriers where the conflicting occurs; and when a priority of the first signal is lower than a priority of a first downlink and/or a first uplink signal, dropping or not transmitting symbols or resources of the first signal across all carriers.

In an embodiment of the present disclosure, wherein when a priority of the first signal is lower than a priority of a first downlink signal and/or a first uplink signal, the method further comprises one or more of the following: if an interval between a time unit and/or frequency unit when decoding of scheduling indication information for the first downlink signal is completed or when the scheduling indication information for the first downlink signal is received and a starting position for transmitting the first signal is less than or not greater than a second threshold, and/or, if an interval between a time unit and/or frequency unit when it is determined to transmit the first uplink signal and a starting position for transmitting the first signal is less than or not greater than a third threshold, the UE determines the priority of the first signal as a high priority; and if after a specific number of time units before a starting position for transmitting the first signal, the UE determines that the UE is expected to receive the first downlink signal and/or transmit the first uplink signal, then the UE determines the priority of the first signal as a high priority.

In an embodiment of the present disclosure, a method performed by a node in a wireless communication system, comprising: transmitting a first message, wherein the first message includes configuration information for bandwidth aggregation of a first signal, wherein the configuration information includes a first power threshold for the bandwidth aggregation of the first signal; and receiving the first signal, wherein the first signal is transmitted by a user equipment (UE) based on the first power threshold.

In an embodiment of the present disclosure, wherein the first message further includes a bandwidth aggregation related indication for indicating whether to enable or activate the bandwidth aggregation of the first signal.

In an embodiment of the present disclosure, further comprising: measuring the first signal according to a number of one or more carriers for the first signal and/or indexes of one or more carriers for the first signal received.

In an embodiment of the present disclosure, further comprising one or more of the following: receiving the first signal on more than one continuous carrier; receiving the first signal on a carrier with the largest bandwidth and/or the highest priority; receiving the first signal on a carrier with the largest bandwidth or on a reference carrier; and receiving the first signal on one carrier.

In an embodiment of the present disclosure, wherein the method further comprises one or more of the following: a starting resource element offset of a first symbol of resources of the first signal received is a starting resource element offset of a reference carrier; a starting resource element offset of a first symbol of resources of the first signal received is: a starting physical resource block of a current carrier plus a number N of guard subcarrier spacings and then taking remainder of a configured comb size for the first signal, where N is greater than or equal to 1; a starting resource element offset of a first symbol of resources of the first signal received is: a frequency unit after removing overlapping subcarriers in frequency domain from a starting physical resource block of a carrier with a high carrier frequency at an overlap, plus a number M of the overlapping subcarriers, and then taking remainder of a configured comb size for the first signal, where M is greater than or equal to 1; and a starting resource element offset of a first symbol of resources of the first signal received is: a frequency unit after removing overlapping subcarriers in frequency domain from a starting physical resource block of a carrier with a high carrier frequency at an overlap, plus a number M of the overlapping subcarriers, and then taking remainder of a subcarrier number 12 for the first signal.

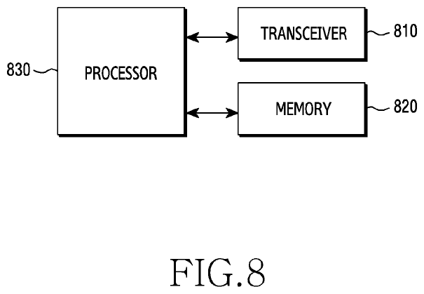

FIG. 8 illustrates a structure of a UE according to various embodiments of the present disclosure.

As shown in FIG. 8, the UE according to an embodiment may include a transceiver 810, a memory 820, and a processor 830. The transceiver 810, the memory 820, and the processor 830 of the UE may operate according to a communication method of the UE described above. However, the components of the UE are not limited thereto. For example, the UE may include more or fewer components than those described above. In addition, the processor 830, the transceiver 810, and the memory 820 may be implemented as a single chip. Also, the processor 830 may include at least one processor. Furthermore, the UE of FIG. 8 corresponds to the UE 111, 112, 113, 114, 115, 116 of the FIG. 1, respectively.

The transceiver 810 collectively refers to a UE receiver and a UE transmitter and may transmit/receive a signal to/from a base station or a network entity. The signal transmitted or received to or from the base station or a network entity may include control information and data. The transceiver 810 may include a RF transmitter for up-converting and amplifying a frequency of a transmitted signal, and a RF receiver for amplifying low-noise and down-converting a frequency of a received signal. However, this is only an example of the transceiver 810 and components of the transceiver 810 are not limited to the RF transmitter and the RF receiver.

Also, the transceiver 810 may receive and output, to the processor 830, a signal through a wireless channel, and transmit a signal output from the processor 830 through the wireless channel.

The memory 820 may store a program and data required for operations of the UE. Also, the memory 820 may store control information or data included in a signal obtained by the UE. The memory 820 may be a storage medium, such as read-only memory (ROM), random access memory (RAM), a hard disk, a CD-ROM, and a DVD, or a combination of storage media.

The processor 830 may control a series of processes such that the UE operates as described above. For example, the transceiver 810 may receive a data signal including a control signal transmitted by the base station or the network entity, and the processor 830 may determine a result of receiving the control signal and the data signal transmitted by the base station or the network entity.

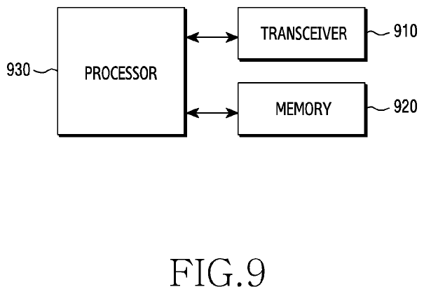

FIG. 9 illustrates a structure of a base station according to various embodiments of the present disclosure.

As shown in FIG. 9, the base station according to an embodiment may include a transceiver 910, a memory 920, and a processor 930. The transceiver 910, the memory 920, and the processor 930 of the base station may operate according to a communication method of the base station described above. However, the components of the base station are not limited thereto. For example, the base station may include more or fewer components than those described above. In addition, the processor 930, the transceiver 910, and the memory 920 may be implemented as a single chip. Also, the processor 930 may include at least one processor. Furthermore, the base station of FIG. 9 corresponds to base station (e.g., BS 101, 102, 103 of FIG. 1).

The transceiver 910 collectively refers to a base station receiver and a base station transmitter and may transmit/receive a signal to/from a terminal (e.g., UE) or a network entity. The signal transmitted or received to or from the terminal or a network entity may include control information and data. The transceiver 910 may include a RF transmitter for up-converting and amplifying a frequency of a transmitted signal, and a RF receiver for amplifying low-noise and down-converting a frequency of a received signal. However, this is only an example of the transceiver 910 and components of the transceiver 910 are not limited to the RF transmitter and the RF receiver.

Also, the transceiver 910 may receive and output, to the processor 930, a signal through a wireless channel, and transmit a signal output from the processor 930 through the wireless channel.

The memory 920 may store a program and data required for operations of the base station. Also, the memory 920 may store control information or data included in a signal obtained by the base station. The memory 920 may be a storage medium, such as read-only memory (ROM), random access memory (RAM), a hard disk, a CD-ROM, and a DVD, or a combination of storage media.

The processor 930 may control a series of processes such that the base station operates as described above. For example, the transceiver 910 may receive a data signal including a control signal transmitted by the terminal, and the processor 930 may determine a result of receiving the control signal and the data signal transmitted by the terminal.

Various embodiments of the present disclosure may be implemented as computer-readable codes embodied on a computer-readable recording medium from a specific perspective. A computer-readable recording medium is any data storage device that can store data readable by a computer system. Examples of computer-readable recording media may include read-only memory (ROM), random access memory (RAM), compact disk read-only memory (CD-ROM), magnetic tape, floppy disk, optical data storage device, carrier wave (e.g., data transmission via the Internet), etc. Computer-readable recording media may be distributed by computer systems connected via a network, and thus computer-readable codes may be stored and executed in a distributed manner. Furthermore, functional programs, codes and code segments for implementing various embodiments of the present disclosure may be easily explained by those skilled in the art to which the embodiments of the present disclosure are applied.

It will be understood that the embodiments of the present disclosure may be implemented in the form of hardware, software, or a combination of hardware and software. The software may be stored as program instructions or computer-readable codes executable on a processor on a non-transitory computer-readable medium. Examples of non-transitory computer-readable recording media include magnetic storage media (such as ROM, floppy disk, hard disk, etc.) and optical recording media (such as CD-ROM, digital video disk (DVD), etc.). Non-transitory computer-readable recording media may also be distributed on computer systems coupled to a network, so that computer-readable codes are stored and executed in a distributed manner. The medium may be read by a computer, stored in a memory, and executed by a processor. Various embodiments may be implemented by a computer or a portable terminal including a controller and a memory, and the memory may be an example of a non-transitory computer-readable recording medium suitable for storing program(s) with instructions for implementing embodiments of the present disclosure. The present disclosure may be realized by a program with code for concretely implementing the apparatus and method described in the claims, which is stored in a machine (or computer)-readable storage medium. The program may be electronically carried on any medium, such as a communication signal transmitted via a wired or wireless connection, and the present disclosure suitably includes its equivalents.

What has been described above is only the specific implementation of the present disclosure, but the scope of protection of the present disclosure is not limited thereto. Anyone who is familiar with this technical field may make various changes or substitutions within the technical scope disclosed in the present disclosure, and these changes or substitutions should be covered within the scope of protection of the present disclosure. Therefore, the scope of protection of the present disclosure should be based on the scope of protection of the claims.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a wireless communication system, the method comprising:
receiving, from a base station, first information configuring a sounding reference signal (SRS) for positioning, wherein the first information includes information on a plurality of component carriers (CCs) which are linked for bandwidth aggregation associated with the SRS for positioning; and
transmitting, to the base station, the SRS for positioning across all of the plurality of CCs.

2. The method of claim 1, further comprising:
receiving, from the base station, second information associated with activating a transmission of the SRS for positioning across all of the plurality of CCs.

3. The method of claim 2, further comprising:
receiving, from the base station, downlink control information (DCI) triggering a resource set of the SRS for positioning across all of the plurality of CCs.

4. The method of claim 1, further comprising:
identifying that an SRS collides with other signal on a symbol of a CC among the plurality of CCs,
wherein, in case that the SRS on the symbol is dropped, an SRS transmission across all of the plurality of the CCs is dropped on the symbol.

5. The method of claim 4, wherein the CC is a CC without an uplink signal, wherein each of the plurality of CCs other than the CC is a CC with the uplink signal, and wherein a time interval is configured for the CC and the plurality of CCs other than the CC.

6. The method of claim 5, wherein the other signal is not transmitted or received during the time interval.

7. The method of claim 6, wherein the time interval is configured between the configured SRS on the CC and the uplink signal on each of the plurality of CCs other than the CC.

8. The method of claim 1, wherein SRS resource set is configured for each of the plurality of CCs and each SRS resource set configured for each of the plurality of CCs is linked each other.

9. A user equipment (UE) in a wireless communication system, the UE comprising:
a transceiver; and
a controller coupled with the transceiver and configured to:
receive, from a base station, first information configuring a sounding reference signal (SRS) for positioning, wherein the first information includes information on a plurality of component carriers (CCs) which are linked for bandwidth aggregation associated with the SRS for positioning, and
transmit, to the base station, the SRS for positioning across all of the plurality of CCs.

10. The UE of claim 9, wherein the controller is further configured to:
receive, from the base station, second information associated with activating a transmission of the SRS for positioning across all of the plurality of CCs.

11. The UE of claim 10, wherein the controller is further configured to:
receive, from the base station, downlink control information (DCI) triggering a resource set of the SRS for positioning across all of the plurality of CCs.

12. The UE of claim 9, wherein the controller is further configured to:
identify that an SRS collides with other signal on a symbol of a CC among the plurality of CCs,
wherein, in case that the SRS on the symbol is dropped, an SRS transmission across all of the plurality of the CCs is dropped on the symbol.

13. The UE of claim 12, wherein the CC is a CC without an uplink signal, wherein each of the plurality of CCs other than the CC is a CC with the uplink signal, and wherein a time interval is configured for the CC and the plurality of CCs other than the CC.

14. The UE of claim 13, wherein the other signal is not transmitted or received during the time interval.

15. The UE of claim 14, wherein the time interval is configured between the configured SRS on the CC and the uplink signal on each of the plurality of CCs other than the CC.
